(19) United States
(12) Patent Application Publication
(10) Pub. No.: US 2023/0115893 A1
(43) Pub. Date: Apr. 13, 2023

(54) DISTANCE MEASURING DEVICE AND DISTANCE MEASURING METHOD

(71) Applicant: Sony Semiconductor Solutions Corporation, Kanagawa (JP)

(72) Inventor: Kumiko Mahara, Kanagawa (JP)

(21) Appl. No.: 17/911,317

(22) PCT Filed: Apr. 2, 2021
(86) PCT No.: PCT/JP2021/014291

§ 371 Date: Sep. 13, 2022

(30) Foreign Application Priority Data
Apr. 16, 2020 (JP) 2020-073445

(51) Int. Cl. G01S 17/89; G01S 7/481; G01S 17/931

(52) U.S. Cl. CPC G01S 17/89; G01S 7/4816; G01S 17/931

(57) ABSTRACT

The present disclosure relates to a distance measuring device and a distance measuring method which, even when a plurality of sensors whose distance measurement systems are different from each other is combined to be used, allow the plurality of sensors to he easily controlled as if a sensor of a single distance measurement system were handled.

A bridge processing part collectively controls operation timings of a plurality of distance measuring sensors such as an iToF sensor, a dToF sensor, and a millimeter-wave sensor and converts distance measurement results of the plurality of distance measuring sensors to common information such as a depth map. The present disclosure is applicable to a distance measuring device.

### TECHNICAL FIELD

The present disclosure relates to distance measuring devices and distance measuring methods and, in particular, to a distance measuring device and a distance measuring method which allow a plurality of sensors whose distance measurement systems are different from each. other to be combined to be used at low costs.

### BACKGROUND ART

In recent years, as a distance measuring system which has been attracting attention, a distance measuring sensor which measures a distance by employing a Time-of-Flight (ToF) method has been attracting attention.

As the distance measuring sensor, there are a. direct ToF system which can measure a comparatively long distance and an indirect ToF system which can measure a comparatively short distance.

For example, Patent Document 1 discloses a distance measuring sensor of a direct ToF system.

In addition, Patent Document 2 discloses a distance measuring sensor of an indirect ToF system.

### CITATION LIST

### patent document

Patent Document 1: International Publication WO 2018/074530

Patent Document 2: Japanese Patent Application Laid-Open No. 2011-86904

### SUMMARY OF THE INVENTION

### Problems to be Solved by the Invention

In the meantime, when a distance measuring device is configured, by using a plurality of distance measuring sensors whose distance measurement systems are difference from each other, it is made possible to cover a wide measuring range.

However, when a distance measuring sensor of a direct ToF system and a distance measuring sensor of an indirect ToF system are simply combined, it is required to respectively control operation of the distance measuring sensor of the direct ToF system and operation of the distance measuring sensor of the indirect ToF system, thereby making the control complicated.

In view of the above-described circumstances, the present disclosure has been devised, and in particular, even when a plurality of sensors whose distance measurement systems are different from each other is combined to be used, it is made possible to easily control the plurality of sensors as if a sensor of a single distance measurement system were handled.

### Solutions to Problems

A distance measuring device of one aspect of the present disclosure is a distance measuring device which includes: a control part that controls a plurality of distance measuring sensors; and a data processing part that generates common information on the basis of distance measurement results of the plurality of distance measuring sensors.

A distance measuring method of another aspect of the present disclosure is a distance measuring method which includes the steps of: controlling a plurality of distance measuring sensors; and generating common information on the basis of distance measurement results of the plurality of distance measuring sensors.

In further another aspect of the present disclosure, a plurality of distance measuring sensors is controlled, and on the basis of distance measurement results of the plurality of distance measuring sensors, common information is generated.

### BRIEF DESCRIPTION OF DRAWINGS

FIG. 1 is a diagram showing an example of detection ranges in a case where a distance measuring device is mounted on a vehicle.

FIG. 2 is a diagram explaining a configuration example of the distance measuring device which includes an iToF sensor and a dToF sensor.

FIG. 3 is a diagram explaining control of a distance measuring device which includes an iToF sensor and a dToF sensor.

FIG. 4 is a diagram explaining an outline of a distance measuring device of the present disclosure.

FIG. 5 is a diagram explaining an example of output results by the distance measuring device in FIG. 4.

FIG. 6 is a diagram explaining a configuration example of a distance measuring device of a preferred embodiment of the present disclosure.

FIG. 7 is a diagram explaining a distance measuring method by the dToF sensor.

FIG. 8 is a diagram explaining a distance measuring method by the iToF sensor.

FIG. 9 is a diagram showing a first configuration example of pixels in a dToF pixel region.

FIG. 10 is a diagram showing a second configuration example of pixels in a dToF pixel region.

FIG. 11 is a diagram showing a third configuration example of pixels of a dToF pixel region.

FIG. 12 is a diagram showing a fourth configuration example of pixels in a dToF pixel region.

FIG. 13 is a diagram showing a first configuration example of pixels in an iToF pixel region.

FIG. 14 is a diagram showing a second configuration example of pixels in an iToF pixel region.

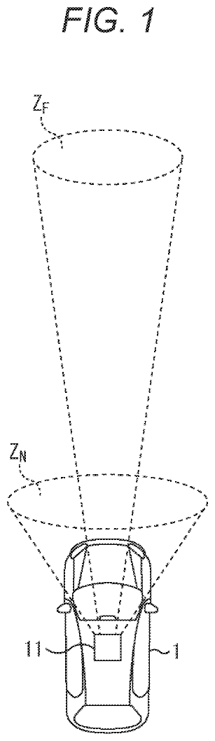

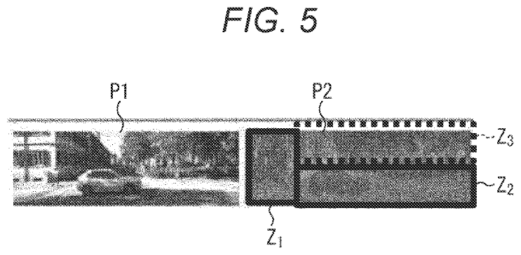

FIG. 1.5 is a timing chart explaining operation of the distance measuring device in FIG. 5.

FIG. 16 is a diagram explaining a variation (part 1) of a distance measuring device of the present disclosure.

FIG. 17 is a diagram explaining a variation (part 2) of a distance measuring device of the present disclosure.

FIG. 18 is a diagram explaining a variation (part 3) of a distance measuring device of the present disclosure.

FIG. 19 is a diagram explaining a variation (part 4) of a distance measuring device of the present disclosure.

FIG. 20 is a timing chart explaining operation of the distance measuring device in FIG. 19.

### MODE FOR CARRYING OUT THE INVENTION

Hereinafter, with reference to the accompanying drawings, a preferred embodiment of the present disclosure will be described in detail. It is to be noted that is the present description and drawings, components having substantially the same function configurations are denoted by the same reference signs and overlapping description is thereby omitted.

In addition, the description will be given in the following order.

1. Outline of the Present Disclosure

2. Preferred Embodiment

3. Modified Examples

<<1. Outline of the Present Disclosure>>

With reference to FIG. 1, an outline of a distance measuring device of the present disclosure will be described by citing a distance measuring device mounted on a vehicle as an example.

As shown in. FIG. 1, in a case where a distance measuring device 11 is mounted on a vehicle 1, with. respect to a traveling direction of the vehicle 1, which is shown in an upper portion of FIG. 1, in order to take collision avoidance action, for example, in a situation in which the vehicle 1 is traveling at a high speed or other situation, it is required to be able to measure a distance up to an object in a region ZF which is farther away from the vehicle 1 than a predetermined distance.

In addition, with respect to the traveling direction which is shown in the upper portion in FIG. 1, in a case where the vehicle 1 is traveling on a narrow road, on which pedestrians are walking, or the like, it is required to be able to measure a distance up to an. object in a region ZN which is closer to the vehicle 1 than the predetermined distance.

In a case where a distance measuring sensor of a ToF system is used, when a region farther away from the vehicle 1, which is shown as the region ZF in FIG. 1, is detected, the distance measuring sensor of the direct ToF system is used, and when a region closer to the vehicle 1, which is shown as the region. ZN in FIG. 1, is detected, the distance measuring sensor of the indirect. ToF system is used.

Hereinafter, the distance measuring sensor of the direct ToF system is referred to as a dToF sensor and the distance measuring sensor of the indirect ToF system is referred to as an iToF sensor.

Here, the iToF sensor is a distance measuring sensor of a system which detects, as a phase difference, time of flight from timing at which distance measuring light is emitted to timing at which reflected light caused when the distance measuring light is reflected by an object is received and calculates a distance up to the object, thereby allowing measurement of a distance in a range closer thereto than the predetermined distance to be realized.

In addition, the dToF sensor is a distance measuring sensor of a system which directly measures time of flight from timing at which distance measuring light is emitted to timing at which reflected light caused when the distance measuring light is reflected by an object and calculates a distance up to the object, thereby allowing measurement of a distance in a range farther away therefrom than the predetermined distance to be realized.

Accordingly, in order to realize measurement of distances up to the objects in both regions of the region ZF which is the region farther away from the vehicle 1 in FIG. 1 and the region ZN which is the region closer to the vehicle 1 in FIG. 1, a distance measuring device 11 which includes at least both of the iToF sensor and the dToF sensor is required.

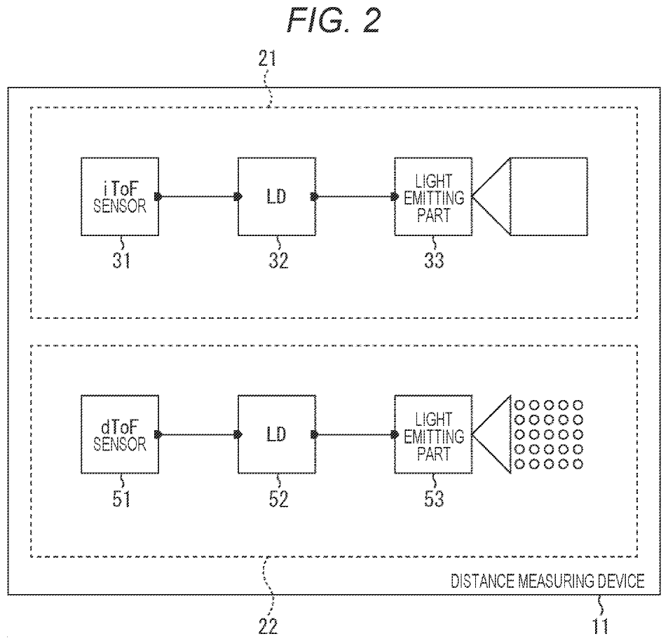

Therefore, in a case where both of the iToF sensor and the dToF sensor are simply included, the distance measuring device 11 is configured as shown in FIG. 2.

The distance measuring device 11 in FIG. 2 includes an iToF block 21 which includes an iToF sensor 31 and a dToF block 22 which includes a dToF sensor 51.

In more detail, the iToF block 21 includes the iToF sensor 31, a laser driver (ID) 32, and a light emitting part 33.

The iToF sensor 31 is constituted of light receiving elements such as current assisted photonic demodulators (CAPDs) and supplies a light emitting trigger which instructs the ID 32 to emit light of the light emitting part 33,

On the basis of the light emitting trigger, the LD 32 continuously modulates the light emitting part 33 constituted of vertical cavity surface emitting laser LEDs (VCSEL LEDs) or the like at a predetermined high frequency and causes the light emitting part 33 to repeat light emission and light turning off.

The iToF sensor 31 detects, as a phase difference of light which is blinking-modulated at a predetermined high frequency of the light emitting part 33, time of flight from timing at which reflected light caused when distance measuring light emitted by the light emitting part 33 is reflected by an object is received and on the basis of the light emitting trigger, the light emitting part 33 is caused to emit light to timing at which the reflected light caused when the light emitted by the light emitting part 33 is reflected by the object is received and calculates a distance up to the object.

In addition, the dToF block 22includes the dToF sensor 51, a laser driver (LD) 52, and a light emitting part 53.

The dToF sensor 51 is constituted of light receiving elements such as single photon avaranche diodes (SPADs) and supplies a light emitting trigger which instructs the ID 52 to emit light of the light emitting part 53.

The LD 52 causes the light emitting part 53 constituted of vertical cavity surface emitting laser LEDs (VCSEL LEDs) or the like, to emit light, for example, as spot light.

The dToF sensor 51 directly detects time of flight from timing at which reflected light caused when distance measuring light emitted by the light emitting part 53 is reflected by an object is received and on the basis of the light emitting trigger, the light emitting part 53 is caused to emit light to timing at which the reflected light, constituted of the spot light, caused when the distance measuring light emitted by the light emitting part 53 is reflected by the object is received and calculates a distance up to the object.

However, since in the distance measuring device 11 having the configuration shown in FIG. 2, the iToF block 21 and the dToF block 22 are provided and the iToF sensor 31 and the dToF sensor 51 are independently configured, it is required to perform mutual time-division processing, thereby making control complex.

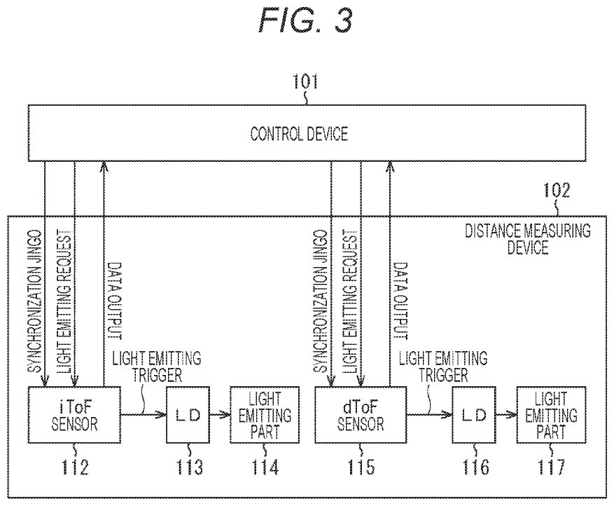

Therefore, for example, as shown in FIG. 3, it is considered that a distance measuring device 102 which is constituted of an iToF sensor 111, an ID 112, and a light emitting part. 113 as well as a dToF sensor 114, an ID 114, and a light emitting part 115 and is provided with two kinds of an iToF sensor and a dToF sensor in an independent mariner is controlled by a control device 101, thereby performing control in which mutual time-division processing is performed.

Here, the iToF sensor 111, the ID 112, and the light emitting part 113 as well as the dToF sensor 114, the LD 115, and the light emitting part 116 correspond to the iToF sensor 31, the LD 32, and the light emitting part 33 as well as the dToF sensor 51, and the ID 52, and the light emitting part 53, which are shown in FIG. 1.

In a case of the, configuration shown in FIG. 3, while the control device 101 supplies synchronizing signals to the iToF sensor 111 and the dToF sensor 114, the control device 101 supplies light emitting requests at mutually different timings.

In accordance with the light emitting requests from the control device 101, the iToF sensor 111 and the dToF sensor 114 generate light emitting triggers, respectively control the LDs 112 and 115, and cause the light emitting parts 113 and 116 to emit distance measuring light.

On the basis of the distance measuring light emitted by the light emitting parts 113 and 116, the iToF sensor 111 and the dToF sensor 114 receive reflected light caused when the distance measuring light is reflected by an object, detect time of flight from timing at which the light emitting triggers are outputted to timing at which the reflected light is received and measure distances.

Alternatively, the control device 101 supplies a synchronizing signal to either one of the iToF sensor 111 and the dToF sensor 114, supplies a light emitting request thereto, and either one thereof which has received the light emitting request outputs a light emitting trigger and causes the light emitting part 113 or 116 to emit distance measuring light, and reflected light from an object is received, thereby performing distance measurement.

At this time, either one of the iToF sensor 111 and the dToF sensor 114, which has received the light emitting request, supplies a light emitting request to the other one of the iToF sensor 111 and the dToF sensor 114, the other one of the iToF sensor 111 and the dToF sensor 114, which has received the light emitting request, causes the light emitting part 113 or 116 to emit light, receives reflected light, and performs distance measurement, and returns data output to the control device 101.

By performing any of the above-described processing, the iToF sensor 111 and the dToF sensor 114 obtain distances up to the objects in a time-division manner.

However, in order to appropriately control the iToF sensor 111 and the dToF sensor 114 so as to avoid overlapping of mutual operations, it is required to output the light emitting requests in consideration of operating time of the iToF sensor 111 and operating time of the dToF sensor 114, thereby making control by the control device 101 cumbersome.

In addition, in a case where formats in which distance measurement results of the iToF sensor 111 and the dToF sensor 114 are shown are different from each other, it is required for the control device 101 to convert the distance measurement results in the different formats to a common format and to merge the distance measurement results into, for example, a depth map or the like, which can be handled as one distance measurement result, thereby making handling of the distance measurement results cumbersome.

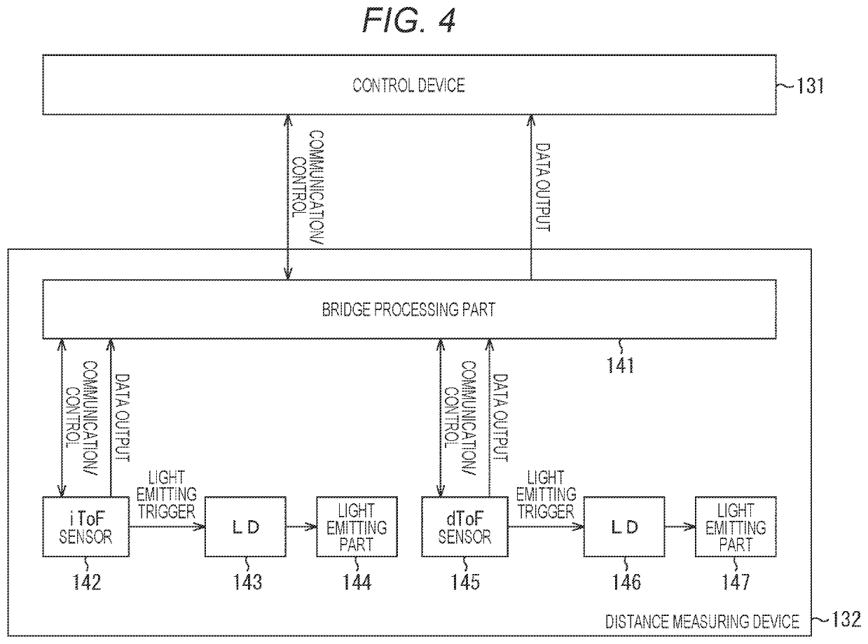

Therefore, in the present disclosure, as shown in FIG. 4, a distance measuring device is provided with a bridge processing part, operations of the iToF sensor and operation of the dToF sensor are controlled, respective output results are synthesized, and a depth map is thereby generated.

In more detail, a distance measuring device 132 in 4 is controlled by a control device 131 and distances up to objects are measured.

The distance measuring device 132 includes a bridge processing part 141, an iToF sensor 142, an LD 143, a light emitting part 144, a dToF sensor 145, an ID 146, and a light emitting part 147.

It is to be noted that the iToF sensor 142, the LD 143, the light emitting part 144, the dToF sensor 145, the LD 146, and the light emitting part 147 basically correspond to the iToF sensor 111, the LD 112, the light emitting part 113, the dToF sensor 114, the LD 115, and the light emitting part 116, which are shown in FIG. 3.

When having accepted, from the control device 131, an instruction showing a distance measurement start, the bridge processing part 141 performs control to avoid overlapping of operation timings of the iToF sensor 142 and the dToF sensor 145, converts distance measurement results obtained by the iToF sensor 142 and the dToF sensor 145 to a common data format such as a depth map, and outputs the common data format to the control device 131.

At this time, for example, by using a distance measurement result of the iToF sensor 142 as to a distance measurement result in a region in a shorter distance than a predetermined distance and by using a distance measurement result of the dToF sensor 145 as to a distance measurement result in a region in a longer distance than a predetermined distance, the bridge processing part 141 generates the depth map.

More specifically, for example, in a case where a vehicle is present on a center front side in an image as shown in an image P1 in FIG. 5, a road extends in the back thereof, and distance measurement is performed for spaces comparatively close to the vehicle in front and back of the vehicle, as to regions Z1 and Z2 as shown in an image P2 in. FIG. 5, distance measurement results by the iToF sensor 142 is used since the regions Z1 and Z2 are in a comparatively short distance range, and as to a region Z3 in a comparatively long distance range, a distance measurement result by the dToF sensor 145 is used, thereby making it possible to enhance distance measurement accuracy as a whole.

Thus, it is only required for the control device 131 to instruct the distance measuring device 132 to start and end distance measurement without controlling timings of the distance measurement, thereby facilitating the control.

In addition, since it is only required for the control device 131 to acquire a processing result of the distance measuring device 132 as the depth map, it is not required to consider where the respective distance measurement results of the iToF sensor 142 and the dToF sensor 145 are reflected, difference in the formats of the distance measurement results of the two sensors, and the like, whereby it is only required to acquire one depth map of as a distance measurement result of one distance measuring sensor.

As a result, the control of the distance measuring device in which the distance measuring sensors of the plurality of distance measurement systems are combined to be used and handling of the distance measurement results can be facilitated.

<<2. Preferred Embodiment>>

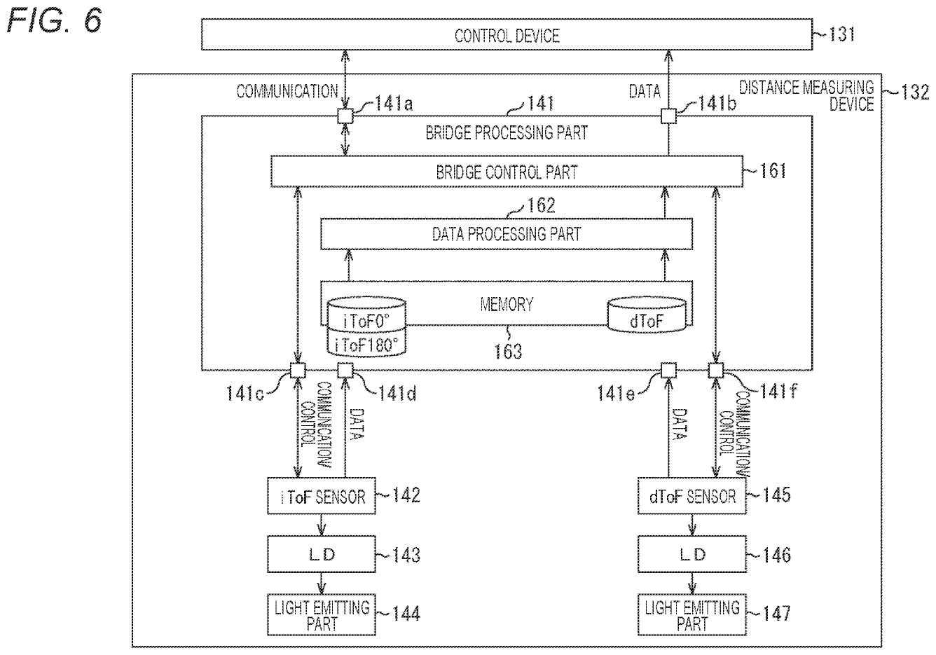

Next, with reference to FIG. 6, a configuration example of a preferred embodiment of a distance measurement system of the present disclosure will be described.

A distance measurement system in FIG. 6 is constituted of a control device 131 and a distance measuring device 132. It is to be noted that the distance measurement system in FIG. 6 shows a detailed configuration of the bridge processing part 141 in the distance measurement system in FIG. 4, components having the same functions as those in FIG. 4 are denoted by the same reference signs, and description therefor will be appropriately omitted.

The bridge processing part 141 includes a bridge control part 161, a data processing part 162, and a memory 163.

The bridge control part 161 controls the whole operation of the bridge processing part 141.

When having received a signal showing an instruction to start or end distance measurement, which is supplied by the control device 131 via a communication interface (IF) 141a, the bridge control part 161 controls an iToF sensor 142 and a dToF sensor 145 via communication control IFs 141c and 141e and causes the iToF sensor 142 and the dToF sensor 145 to execute the distance measurement.

At this time, since if the iToF sensor 142 and the dToF sensor 145 operate for the distance measurement at the same timing, interference due to distance measuring light is caused and appropriate distance measurement cannot be realized, operation timing is controlled by time division control such that distance measurement operation of the iToF sensor 142 and distance measurement operation of the dToF sensor 145 are not performed at the same timing.

The bridge control part 161 acquires data of distance measurement results by the iToF sensor 142 and the dToF sensor 145 via data IFs 141d and 141f and causes the memory 163 to store the data.

The bridge control part 161 controls the data processing part 162 and on the basis of the data of the distance measurement results by the iToF sensor 142 and the dToF sensor 145, which is stored in the memory 163, and causes the data processing part 162 to generate a depth map.

The bridge control part 161 outputs the depth map generated by the data processing part 162 to the control device 131 via a data IF 141b.

<Distance Measuring Method by dToF Sensor>

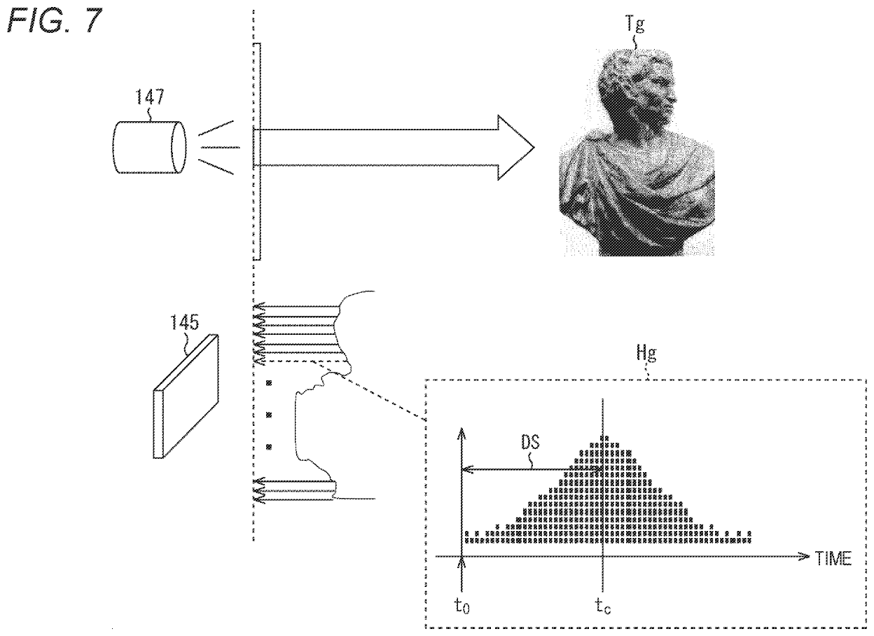

Next, with reference to FIG. 7, a distance measuring method by the dToF sensor 145 will be described.

As shown in an upper row i.e. FIG. 7, when distance measuring light indicated by a right-pointing arrow in FIG. 7 emitted by a light emitting part 147 is reflected by an object Tg, reflected light indicated by left-pointing arrows in FIG. 7 is caused, photons constituting the reflected light are received by pixels constituted of SPADs constituting the dToF sensor 145 and pixel signals in accordance with amounts of light are sampling-processed.

On the basis of the sampled pixel signals, the dToF sensor 145 generates a histogram Hg as shown in a right lower row in FIG. 7.

In more detail, the dToF sensor 145 adds a plurality of pixel signals for removing influence of light from outside and a dark current and generates the histogram Hg from an integration result obtained by repeating light emission and light reception at a plurality of times.

On the basis of the histogram Hg and time Ds which. is a difference between time t0 which is light emitting timing and peak time tp of timing at which the reflected light is received, the dToF sensor 145 calculates a distance in accordance with a detection result of the pixels.

<Distance Measuring Method by iToF Sensor>

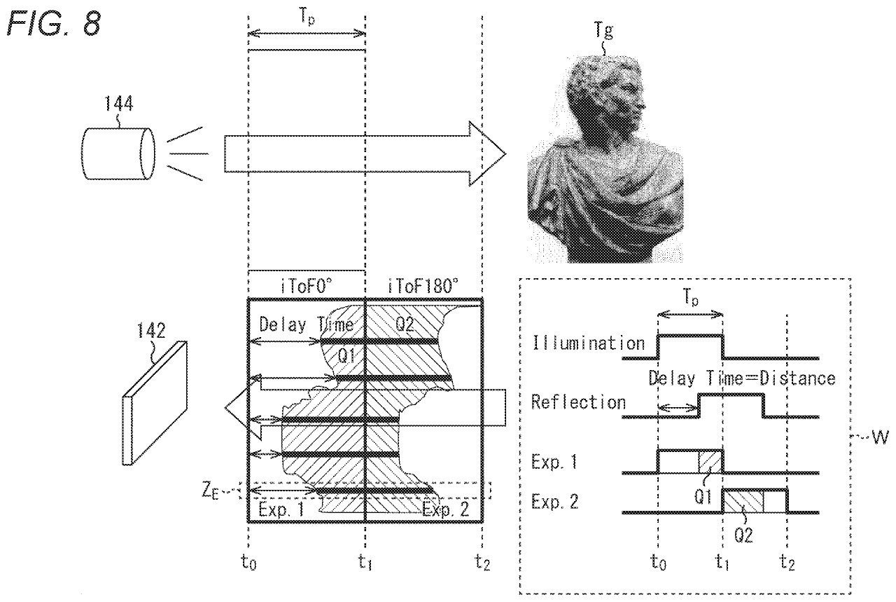

Next, with reference to FIG. 8, a distance measuring method by the iToF sensor 142 will be described.

As shown in an upper portion of FIG. 8, the iToF sensor 142 accumulates, as pixel signals obtained at first timing being different by a predetermined phase difference and pixel signals obtained at second timing, reflected light indicated by left-pointing arrows, the reflected light caused when distance measuring light, indicated by a right-pointing arrow, caused when the light emitting part 144 repeats light emission and Light turning off at a high frequency is reflected by the object Tg.

Here, since the predetermined phase difference is an equal interval and the phase difference can be deemed as 180°, as to the same pixel, each pixel signal obtained at the first timing is referred to as a pixel signal iToF 0° and each pixel signal obtained at the second timing is referred to as a pixel signal iToF 180°.

In addition, in a lower left portion of FIG. 8, an accumulation result of pixel signals iToF0° at the first timing is a pixel value Q1 indicated by an area hatched by diagonally right-up lines, and an accumulation result of the pixel signals at the second timing being different by the predetermined phase difference with respect to the first timing is a pixel value Q2 indicated by an area hatched by diagonally right-down lines.

At this time, in a case where light emitting timing of the light emitting part 144 in a dotted line frame W in a lower right portion of FIG. 8 is shown by a waveform Illumination and the light emitting part 144 emits light only for a period of time Tp from time t0, reflected light after the reflection by the object Tg is received, whereby light of, for example, a waveform Reflection showing light receiving timing is received as light of a waveform, which results by delaying the distance measuring light by time during which the distance measuring light reciprocates a distance from the light emitting part 144 to the object Tg.

In addition, when the pixel signals iToF0° receive the reflected light at timing shown by a waveform Exp.1 and the pixel signals iToF 180° receive the reflected light at timing shown by a waveform Exp.2, for example, as to predetermined pixels corresponding to a range LE enclosed by a dotted line in a lower left portion of FIG. 7, the pixel value Q1 of the pixel signals iToF0° corresponds to a diagonally right-up lined portion of the whole area of a rectangular waveform Exp.1, and the pixel value Q2 of the pixel signals iToF 180° corresponds to a diagonally right-down lined portion of the whole area of a rectangular waveform Exp.2.

Therefore, by using a ratio between the pixel values Q1 and Q2, the iToF sensor 142 obtains delay time (Delay Time) at the light receiving timing of the reflected light and on the basis of the delay time (Delay Time), calculates a distance (Distance) up to the object Tg.

<First Example of Pixels Constituting dToF Sensor>

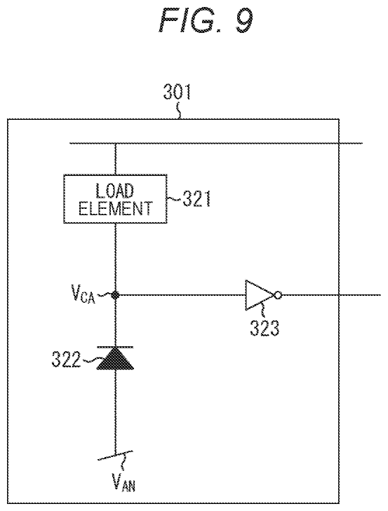

Next, with reference to FIG. 9, a first example of pixels constituting the dToF sensor 145 will be described.

Pixels 301 constituting the dToF sensor 145 in FIG. 9 are constituted of a load element (LOAD element) 321, a photoelectric conversion element 322 constituted of SPADs, and an inverter 323.

In more detail, one terminal of the load element 321 is connected to a power source potential Vcc, and the other terminal thereof is connected to a cathode of the photoelectric conversion element 322 and to an input terminal of the inverter 323.

The cathode of the photoelectric conversion element 322 is connected to the other terminal of the load element 321 and to the input terminal of the inverter 323, and a predetermined power source potential V_{AN} is applied to an anode thereof from outside.

The other terminal of the load element 321 and the cathode of the photoelectric conversion element 322 are connected to the input terminal of the inverter 323.

The pixels 301 in FIG. 9 have a configuration called a passive restoration (passive recharge) circuit and passively restores a voltage drop caused by quenching.

<Second Example of Pixels Constituting dToF Sensor>

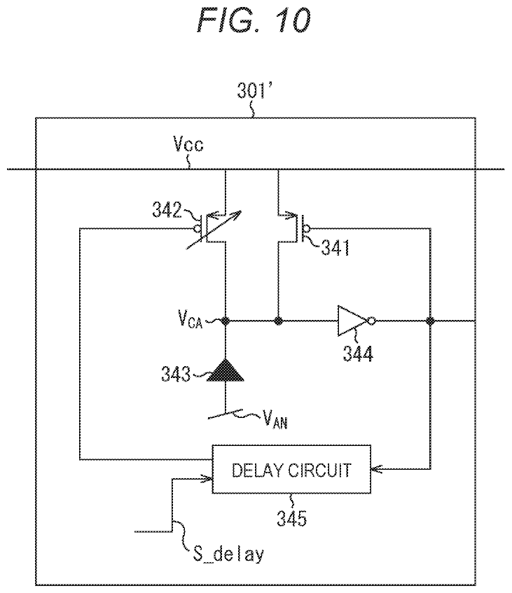

Next, with reference to FIG. 10, a second example of pixels constituting the dToF sensor 145 will be described.

The pixels 301′ constituting the dToF sensor 145 in FIG. 10 is constituted of MOSFETs 341 and 342, a photoelectric conversion element 343 constituted of SPADs, an inverter 344, and a delay circuit 345.

In more detail, a source of the MOSFET 341 is connected to a power source potential Vcc, a gate thereof is connected to an input terminal of the inverter 344 and to an input terminal of the delay circuit 345, a drain thereof is connected to a cathode of the photoelectric conversion element 343, to a drain of the MOSFET 342, and to an input terminal of the inverter 344.

A source of the MOSFET 342 is connected to the power source potential Vcc, a gate thereof is connected to an output terminal of the delay circuit 345, and a drain thereof is connected to the cathode of the photoelectric conversion element 343, to the drain of the MOSFET 341, and to the input terminal of the inverter 344.

A cathode of the photoelectric conversion element 343 is connected to drains of the MOSFETs 341 and 342 and to the input terminal of the inverter 323, and a predetermined power source potential AN is applied to an anode thereof from outside.

An input terminal of the inverter 344 is connected to sources of the MOSFETs 341 and 342 and to a cathode of the photoelectric conversion element 322.

An input terminal of the delay circuit 345 is connected to a gate of the MOSFET 341 and an output terminal of the inverter, and an output terminal thereof is connected to a gate of the MOSFET 342.

The pixels 301′ in FIG. 10 have a configuration called an active restoration (active recharge) circuit and on the basis of output of the inverter 344 and an adjustment signal S delay, the delay circuit 345 outputs a delay signal to the gate of the MOSFET 342, thereby actively restoring a voltage drop caused by quenching.

<Third Example of Pixels Constituting dToF Sensor>

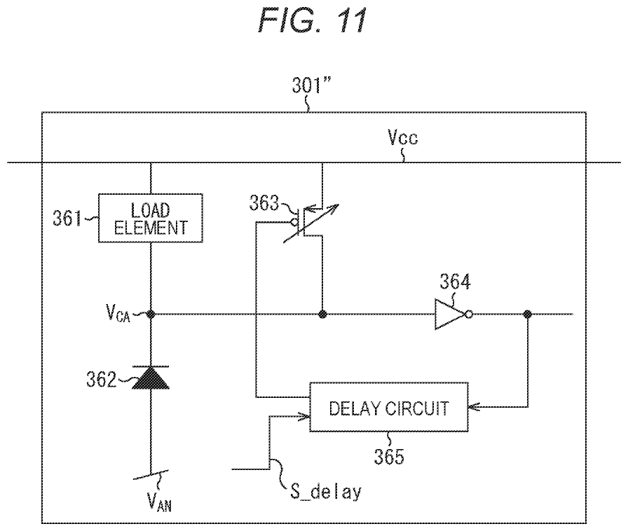

Next, with reference to FIG. 11, a third example of pixels constituting the dToF sensor 145 will be described.

The pixel 301″ constituting the dToF sensor 145 in. FIG. 11 is constituted of a load element (LOAD element) 361, a photoelectric conversion element 362 constituted of SPADs, a MOSFET 363, an inverter 364, and a delay circuit 365.

In more detail, one terminal of the load element 361 is connected to a power source potential Vcc and the other terminal thereof is connected to a cathode of a photoelectric conversion element 322, to a drain of the MOSFET 363, and to an input terminal of the inverter 364.

A cathode of the photoelectric conversion element 362 is connected to the other terminal of the load element 361, to a drain of the MOSFET 363 and to the input terminal of the inverter 323 and a predetermined power source potential V_{AN} is applied to an anode thereof from outside.

A source of the MOSFET 363 is connected to the power source potential Vcc, a gate thereof is connected to an output terminal of the delay circuit 365, and a drain thereof is connected to the other terminal of the load element 361, to the cathode of the photoelectric conversion element 362, and to the input terminal of the inverter 364.

The input terminal of the inverter 364 is connected to the other terminal of the load element 361, to a cathode of a photoelectric conversion element 322, and to the drain of the MOSFET 363, and an output terminal thereof is connected to an input terminal of the delay circuit 365.

An input terminal of the delay circuit 365 is connected to the output terminal of the inverter 364 and the output terminal thereof is connected to the gate of the MOSFET 363.

The pixels 301″ in FIG. 11 has a configuration called an active restoration (active recharge) circuit and on the basis of output of the inverter 364 and an adjustment signal S_delay, the delay circuit 365 outputs a delay signal to the gate of the MOSFET 363, thereby actively restoring a voltage drop caused by quenching.

<Fourth Example of Pixels Constituting dToF Sensor>

Although hereinbefore, the pixels constituted of the passive restoration (passive recharge) circuit and the pixels constituted of the active restoration (active recharge) circuit have been described, both thereof may be combined and be used by switching these.

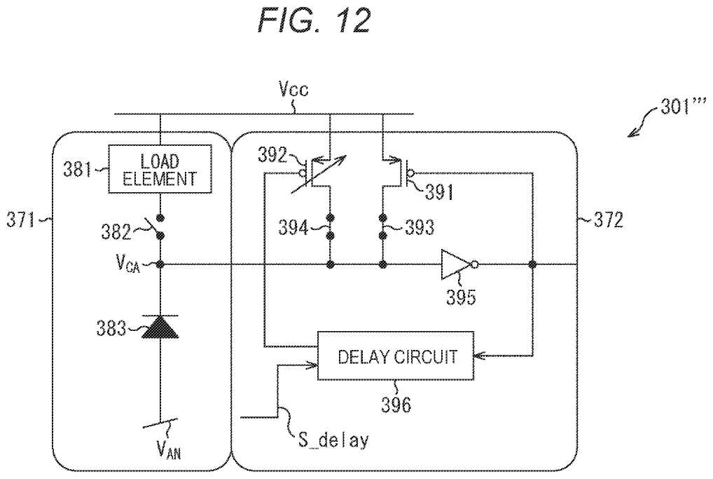

In other words, FIG. 12 shows an example of pixels constituting a dToF sensor 145 in which the pixels constituted of the passive recharge circuit and the pixels constituted of the active recharge circuit are combined and switching is performed when used.

The pixels 301′″ constituting the dToF sensor 145 in FIG. 12 is constituted of a passive configuration part 371 and an active configuration part 372.

The passive configuration part 371 includes a load element (LOAD element) 381, a switch 382, and a photoelectric conversion element 383 constituted of SHADS.

In addition, the active configuration part 372 includes MOSFETs 391 and 392, switches 393 and 394, an inverter 395, and a delay circuit 396.

Here, the load element 381 and the photoelectric conversion element 383 of the passive configuration part 371 and the inverter 395 of the active configuration part 372 correspond to the load element 321, the photoelectric conversion element 322, and the inverter 323, which are shown in FIG. 9.

In addition, the MOSFETs 391 and 392, the inverter 395, and the delay circuit 396 of the active configuration part 372 correspond to the MOSFETs 341 and 342, the inverter 344, and the delay circuit 345, which are shown in FIG. 10.

Then, by mutually and exclusively switching on/off of the switch 382 and the switches 391 and 392, it is switched whether the passive configuration part 371 is caused to function or the active configuration part 372 is caused to function.

In FIG. 12, a state in which the active configuration part 372 functions by turning the switch 382 off and turning the switches 391 and 392 on is shown. Of course, conversely to the state in FIG. 12, by turning the switch 382 on and turning the switches 391 and 392 off, the state can be switched to a state in which the passive configuration part 371 functions.

<First Example of Pixels Constituting iToF Sensor>

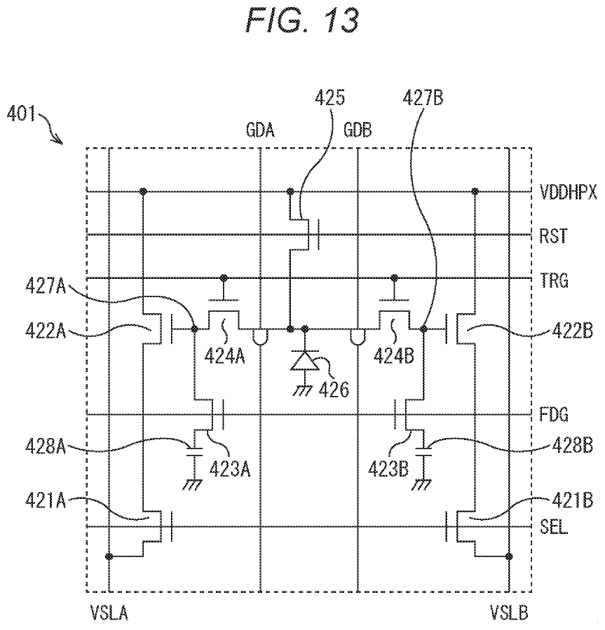

Next, with reference to FIG. 13, a first example of pixels constituting an iToF sensor 142 will be described. It is to be noted that the pixels constituting the iToF sensor 142 are divided into two regions and are controlled to operate in a state in which phase differences at predetermined time intervals are caused. Herein, as to components respectively corresponding to the two regions, “A” and “B” are added to reference signs to distinguish the components in the two regions.

The pixels 401 in FIG. 13 include selection transistors 421A and 421B, amplification transistors 422A and 422B, FD gate transistors 423A and 423B, transfer transistors 424A and 424B, a reset transistor 425, a PD (photoelectric conversion element) 426, additional capacitances 427A and 427B, and FDs (floating diffusion regions) 428A and 428B.

When a transfer driving signal TRG supplied to gates of the transfer transistors 424A and 424B is activated, the transfer transistors 424A and 424B come to be in a conductive state and transfer an electric charge accumulated in the PD 426 to the FD 427A and 427B.

It is to be noted that although in FIG. 13, one transfer driving signal TRG is provided and shares the transfer transistors 424A and 424B, in reality, the transfer transistors 424A and 424B are provided individually with transfer driving signals TRG, and the transfer driving signals TRG are controlled to be turned on or off such that the transfer transistors 424A and 424B respectively exclusively operate.

The FDs 428A and 428B are electric charge accumulation parts which temporarily accumulate and retain the electric charge transferred from the PD 426.

When an FD driving signal FDG supplied to gates of the FD gate transistors 423A and 423B comes to be in an active state, the FD gate transistors 423A and 423B come to be in a conductive state and are connected to the PDs 448A and 4488 and the additional capacitances 429A and 429B.

It is to be noted that although in FIG. 13, one FD driving signal FDG is provided and share the FD gate transistors 423A and 423B, in reality, the FD gate transistors 423A and 423B are provided individually with FD driving signals FDG and the FD driving signals FDG are controlled to be turned on or off such that the FD gate transistors 423A and 423B respectively exclusively operate.

When a reset driving signal RST supplied to a gate of the reset transistor 425 comes to be in an active state, the reset transistor 425 comes to be in a conductive state and resets an electric potential of the PD 426.

Source electrodes of the amplification transistors 422A and. 4225 are connected to vertical transfer lines VSLA and VSLB via the selection transistors 421A and 421B and the amplification transistors 422A and 422B are thereby connected to a constant current source, not shown, thereby, constituting a source follower circuit.

The selection transistors 421A and 421B are connected between the amplification transistors 422A and 422B and the vertical transfer lines VSLA and VSLB, come to be in a conductive state when a selection signal SEL supplied to gates of the selection transistors 421A and 4215 comes to be in an active state, and output signals outputted from the amplification transistors 422A and 422B to the vertical transfer lines VSLA and VSLB.

It is to be noted that although in FIG. 13, one selection signal SEL is provided and shares the selection transistors 421A and 421B, in reality, the selection transistors 421A and 421B are individually provided with selection signals SEL and the selection signals SEL are controlled to be turned on or off such that the selection transistors 421A and 421B respectively exclusively operate.

Next, operation of the pixels 401 in FIG. 13 will be described.

Before performing light reception, electric charges of the whole pixels 401 are reset.

In other words, the PD gate transistors 423A and 423B, the transfer transistors 424A and 424B, and the reset transistor 425 are turned on, and the electric charges accumulated in the PD 447 and the FDs 448A and 448B are discharged.

After discharging the accumulated electric charges, light reception in the whole pixels 401 is started.

In other words, the transfer transistors 424A and 424B are alternately driven. Thus, the electric charge accumulated by the PD 426 is alternately distributed to the FDs 428A and 428B to be accumulated.

Reflected light which the pixels 401 receive is received after distance measuring light emitted by the light source is delayed by time in accordance with a distance up to the object from timing at which the distance measuring light is emitted.

At this time, as described with reference to FIG. 8, since distribution of the electric charges accumulated in the FDs 428A and 428B change by delay time in accordance with the distance up to the object, it is made possible to obtain the distance up Co the object from a distribution ratio of the electric charges accumulated in the FDs 428A and 428B.

<Second Example of Pixels Constituting iToF Sensor>

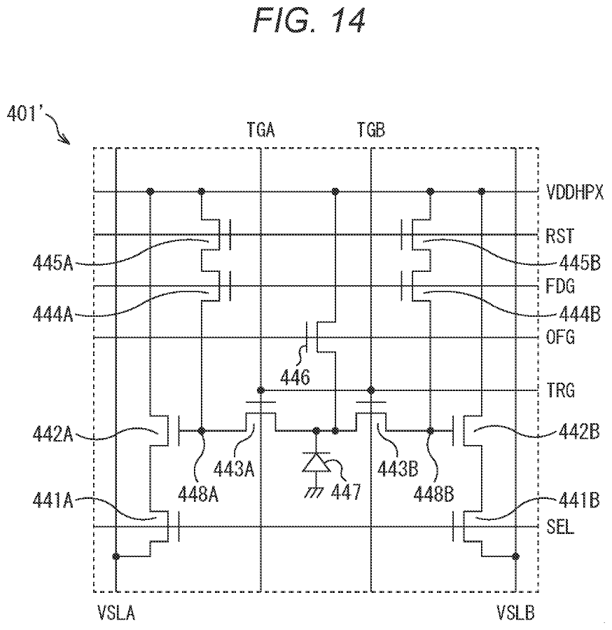

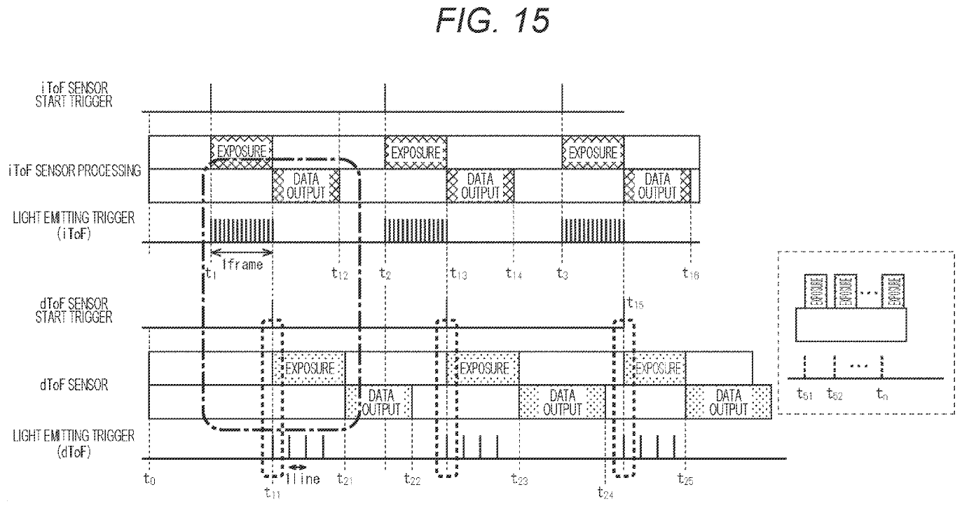

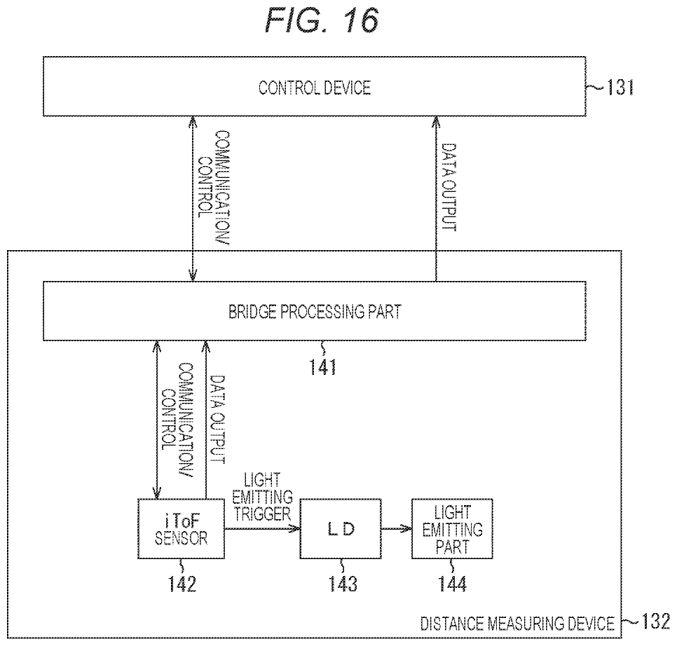

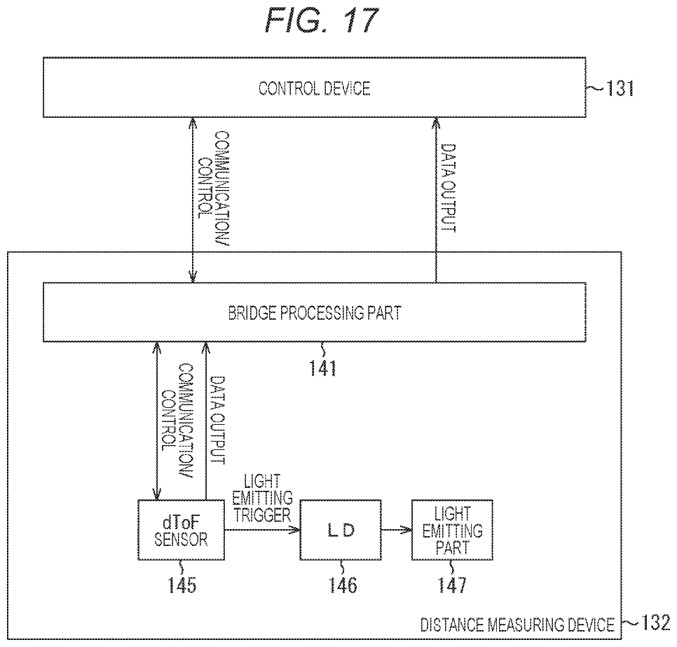

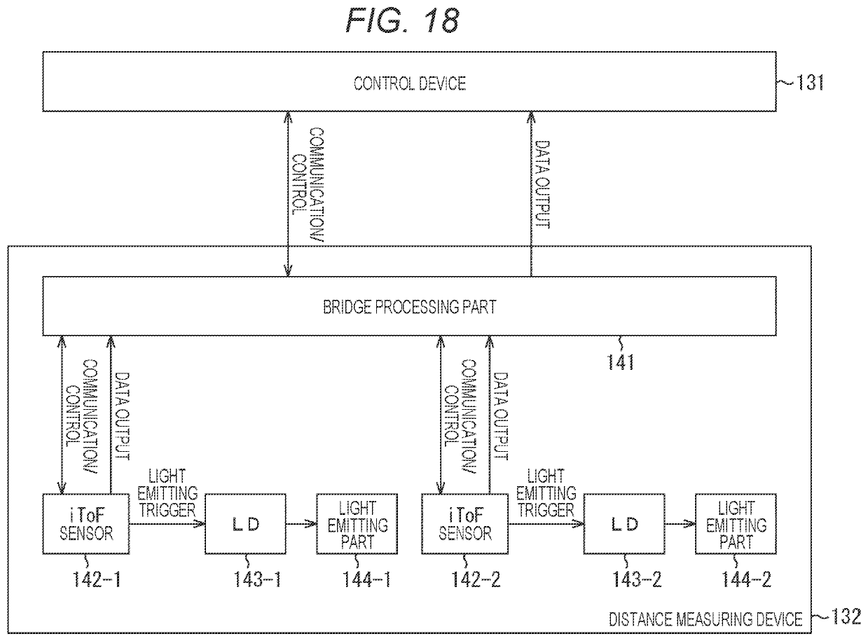

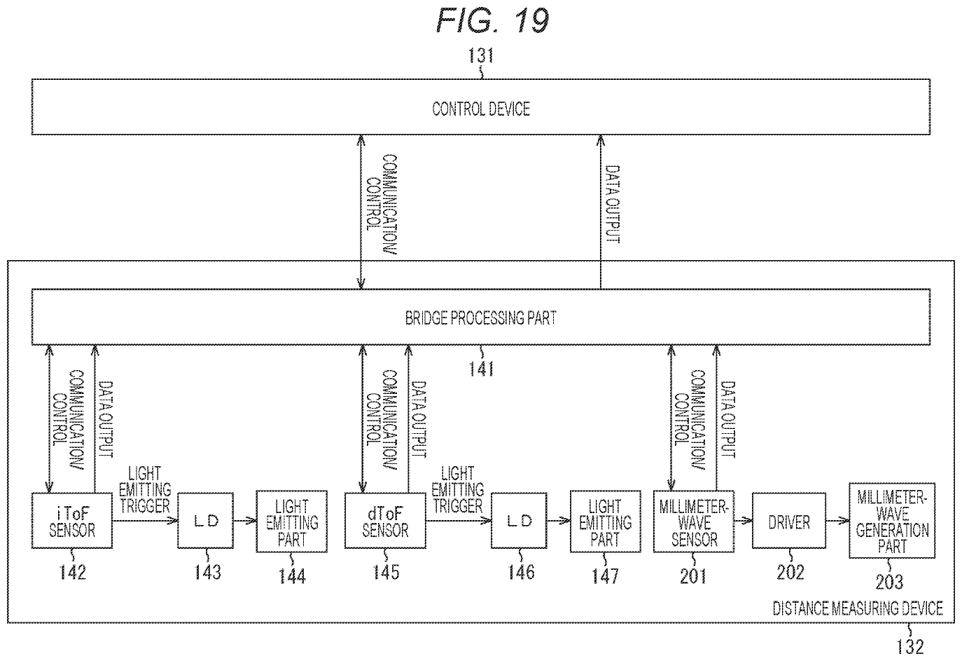

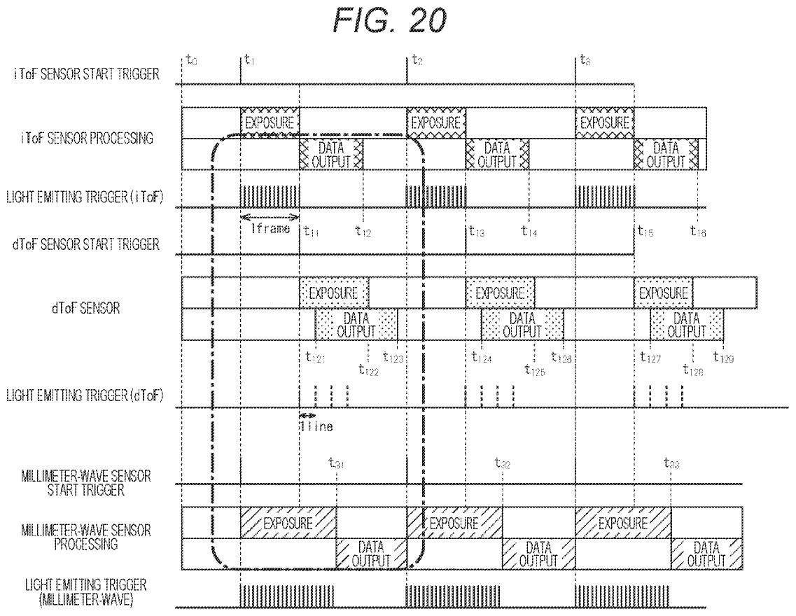

Next, with reference to FIG. 14, a second example of pixels constituting the iToF sensor 142 will be described.

The pixels 401′ in FIG. 14 include selection transistors 441A and 441B, amplification transistors 442A and 442B, transfer transistors 443A and 443B, FD gate transistors 444A and 444B, reset transistors 445A and 445B, an overflow gate transistor 446, a PD (photoelectric conversion element) 447, and FDs (floating diffusion regions) 448A and 448B.

When a transfer driving signal TRG supplied to gates of the transfer transistors 443A and 443B is activated, the transfer transistors 443A and 443B come to be in a conductive state, an electric charge accumulated in the PD 447 is transferred to the FDs 448A and 448B.

It is to be noted that although in FIG. 14, one transfer driving signal TRG is provided and shares the transfer transistors 443A and 443B, in reality, the transfer transistors 443A and. 443B are provided individually with transfer driving signals TRG and the transfer driving signals TRG are controlled be to turned on or off such that the transfer transistors 443A and 443B respectively exclusively operate.

The FDs 448A and 448B are electric charge accumulation parts which temporarily accumulate and. retain the electric charge transferred from the PD 447.

When an FD driving signal FDG supplied to gates of the FD gate transistors 444A and 444B comes to be in an active state, the FD gate transistors 444A and 444B come to be in a conductive state and are connected to the FDs 448A and 448B and the reset transistors 445A and 445B.

It is to be noted that although in. FIG. 14, one FD driving signal FDG is provided and shares the ED gate transistors 444A and 444B, in reality, the FD gate transistors 444A and 444B are provided individually with FD driving signals FDG, and the FD driving signals FDG are controlled to be turned on or off such that the PD gate transistors 444A and 444B respectively exclusively operate.

When a reset driving signal RST supplied to gates of the reset transistors 445A and 445B come to be in an active state, the reset transistors 445A and 445B come to be in a conductive state, are connected to the FD gate transistors 444A and 444B, and reset electric potentials of the FDs 448A and 448B when the FD gate transistors 444A and 444B are in a conductive state.

It is to be noted that although in FIG. 14, one reset driving signal RST is provided and share the reset transistors 445A and 445B, in reality, the reset transistors 445A and 445B are provided individually with reset driving signals RST, and the reset driving signals RST are controlled to be turned on or off such that the reset transistors 445A and 4458 respectively exclusively operate.

When a discharge driving signal OFG supplied to a gate of the overflow gate transistor 446 comes to be in an active state, the overflow gate transistor 446 comes to be in a conductive state and discharges an electric charge accumulated in the PD 447.

Source electrodes of the amplification transistors 442A and 442B are connected to vertical transfer lines VSLA and VSLB via the selection transistors 441A and 441B and the amplification transistors 442A and 442B are connected to a constant current source, not shown, thereby constituting a source follower circuit.

The selection transistors 441A and 441B are connected between the amplification transistors 442A and 442B and the vertical transfer lines VSLA and VSLB, conic to be in a conductive state when a selection signal SEL supplied to gates of the selection transistors 441A and 441B comes to be in an active state, and output signals outputted by the amplification transistors 442A and 442B to the vertical transfer lines VSLA and VSLB.

It is to be noted that although in FIG. 14, one selection signal SEL is provided and shares the selection transistors 441A and 441B, in reality, the selection transistors 441A and 441B are provided individually with selection signals SEL, and the selection signals SEL are controlled to be turned on or off such that the selection transistors 441A and 441B respectively exclusively operate.

Next, the pixels 401′ in FIG. 14 will be described.

Before performing light reception, electric charges in the whole pixels 401′ are reset.

In other words, the FD gate transistors 444A and 444B, the overflow gate transistor 446, and the reset transistors 445A and 445B are turned on, and the electric charges accumulated in the PD 447 and the FDs 448A and 448B are discharged.

After discharging the accumulated electric charges, light reception in the whole pixels 401′ is started.

In other words, the transfer transistors 443A and 443B are alternately driven. Thus, the electric charge accumulated by the PD 447 is alternately distributed to the FDs 448A and 448B to be accumulated.

Reflected light which the pixels 401′ receive is received after distance measuring light emitted by the light source is delayed by time in accordance with a distance up to the object from timing at which the distance measuring light is emitted.

At this time, as described with reference to FIG. 8, since distribution of the electric charges accumulated in the FDs 448A and 448B change by delay time in accordance with the distance up to the object, it is made possible to obtain the distance up to the object from a distribution ratio of the electric charges accumulated in the FDs 448A and 448B.

<Operation of Distance Measuring Device in FIG. 6>

Next, with reference to a timing chart in FIG. 15, operation of the distance measuring device 132 in FIG. 6 will be described.

It is to be noted that in the timing chart in an upper row in FIG. 15, from the top, a trigger to start operation of an iToF sensor 142 (iToF sensor start trigger); exposure timing and data output timing of the iToF sensor 142 (iToF sensor processing); timing of a light emitting trigger (iToF) to cause the iToF sensor 142 to emit distance measuring light (light emitting trigger (iToF)); a trigger to start operation of a dToF sensor 145 (dToF sensor start trigger); exposure timing and data output timing of the dToF sensor 145 (dToF sensor processing); and timing of light emitting trigger (dToF) to cause the dToF sensor 145 to emit distance measuring light (dToF sensor start trigger) are shown.

In a case where the iToF sensor and the dToF sensor measure distances in the same range at the same timing, since interference due to differences in frequencies and intensities of the distance measuring light of both thereof is caused, it is required to cause the iToF sensor and the dToF sensor to operate at timings which are different from each other by utilizing time-division processing.

In other words, as shown in the upper row in FIG. 15, in a case where the iToF sensor 142 is caused to first operate, for example, at time to, when an instruction indicating that distance measurement is started is supplied by the control device 131, at time t1, the bridge control part 161 supplies the iToF sensor start trigger which instructs the iToF sensor 142 to start emitting of the distance measuring light.

At time t1 to t11, on the basis of the iToF sensor start trigger, the iToF sensor 142 outputs the light emitting trigger (iToF) to emit the distance measuring light from the light emitting part 144 to the LD 143 at a predetermined frequency.

The LD 143 controls the light emitting part 144 by this light emitting trigger (iToF) and causes the light emitting part 144 to repeat light emission and light turning off, for example, in a frame unit at the predetermined frequency and to emit the distance measuring light.

In response to this, as shown in the iToF sensor processing, at time t1 to t11, the iToF sensor 142 performs exposure to receive reflected light and accumulates pixel signals iToF0° and pixel signals iToF 180° in accordance with an amount of the received light as exposure results in he memory 163.

Then, at time t11, when light emission of the light emitting part 144 for the iToF sensor 142 and the exposure by the iToF sensor 142 have been finished, at time t11 to t12, on the basis of the exposure results of the pixel signals iToF0° and pixel signals iToF 180°, which are accumulated in the memory, the iToF sensor 142 executes data processing described with reference to FIG. 8, generates a distance measurement result, and causes the memory 163 to store the distance measurement result (data output).

On the other hand, at time t11, since the light emission of the distance measuring light to the iToF sensor 142 has been finished, the bridge control part 161 supplies the dToF sensor start trigger which instructs the dToF sensor 145 to start light emission of the distance measuring light.

At time t11 to t12, on the basis of the dToF sensor start trigger, the dToF sensor 145 generates the light emitting trigger (dToF) to cause the light, emitting part 147 to emit light at a predetermined frequency and outputs the light emitting trigger (dToF) to the LD 146.

On the basis of This light emitting trigger (dToF), the ID 146 controls the light emitting part 147 and causes the light emitting part 147 to repeat light emission and light turning off, for example, in a line unit and to project distance measuring light.

In response to this, at time t11 to t21, the dToF sensor 145 performs exposure to receive reflected light and accumulates pixel signals dToF in accordance with an amount of received light as an exposure result in the memory 163.

Then, at time t21, when the light emission of the light emitting part 147 to the dToF sensor 145 and the exposure by the dToF sensor 145 have been finished, at time t21 to t22, on the basis of the accumulated pixel signals dToF as the exposure result, the dToF sensor 145 executes the data processing described with reference to FIG. 7, generates a distance measurement result, and causes the memory 163 to store the distance measurement result.

Furthermore, on the basis of the distance measurement result of the iToF sensor 142 and the distance measurement result of the dToF sensor 145, which are stored in the memory 163, for example, as descried with reference to FIG. 5, the data processing part 162 uses the processing result of the iToF sensor 142 as to the pixels of the distance measurement result closer thereto than the predetermined distance and uses the processing result of the dToF sensor 145 as to the pixels of the distance measurement result farther away therefrom than the predetermined distance, thereby generating a depth map and outputting the depth map to the bridge control part 161.

In other words, the data processing part 162 converts the distance measurement result of the iToF sensor 142 and the distance measurement result of the dToF sensor 145, the distance measurement system of the iToF sensor 142 and the distance measurement system of the dToF sensor 145 being different from each other, to the depth map which is the common data format and outputs the depth map as one distance measurement result to the bridge control part 161.

The bridge control part 161 outputs the depth map supplied from the data processing part 162 to the control device 131 via the data IF 141b (data output).

At time t2, the bridge control part 161 supplies the iToF sensor start trigger, which instructs the iToF sensor 142 to start the light emission of the distance measuring light, to the iToF sensor.

Furthermore, at time t2 to t13, on the basis of the iToF sensor start trigger, the iToF sensor 142 outputs the light emitting trigger(iToF), which causes the distance measuring light to be emitted from the light emitting part 144, to the LD 143 at the predetermined frequency.

The ID 143 controls the light emitting part 144 by this light emitting trigger (iToF) and causes the light emitting part 144 to repeat light emission and light turning off, for example, in a frame unit at the predetermined frequency and to emit the distance measuring light.

In response to this, as shown in the iToF sensor processing, at time t2 to t13, the iToF sensor 142 performs the exposure to receive the reflected light and accumulates, as the exposure result, the pixel signals ToF0° and the pixel signals iToF 180° in accordance with the amount of the received light in the memory 163.

Then, at time t13, when the light emission of the light emitting part 144 to the iToF sensor 142 and the exposure by the iToF sensor 142 have been finished, at time t13 to t14, on the basis of the exposure result including the pixel signals iToF0° and the pixel signals iToF 180°, which are accumulated in the memory 163, the iToF sensor 142 executes the data processing described with reference to FIG. 8, generates the distance measurement result, and causes the memory 163 to store the distance measurement result (data output).

On the other hand, at time t13, since the light emission of the distance measuring light to the iToF sensor 142 has been finished, the bridge control part 161 supplies the dToF sensor start trigger, which instructs the dToF sensor 145 to start the light emission of the distance measuring light, to the dToF sensor 145.

At time t13 to t23, on the basis of the dToF sensor start trigger, the dToF sensor 145 outputs the light emitting trigger(dToF), which causes the light emitting part 147 to emit light, to the LD 146.

On the basis of this light emitting trigger (dToF), the LD 146 controls the light emitting part 147 and causes the light emitting part 147 to repeat light emission and light turning off, for example, in a line unit and to project distance measuring light.

In response to this, at time t13 to t23, the dToF sensor 145 performs the exposure to receive the reflected light and causes the memory 163 to accumulate, as the exposure result, the pixel signals dToF in accordance with the amount of the received light.

Then, at time 123, when the light emission of the light emitting part to the dToF sensor 145 and the exposure by the dToF sensor 145 have been finished, at time t.23 to t24, on the basis of the pixel signals dToF accumulated in the memory 163 as the exposure result, the dToF sensor 145 executes the data processing described with reference to FIG. 7, generates the distance measurement result, and causes the memory 163 to store the distance measurement result.

Furthermore, on the basis of the processing result of the iToF sensor 142 and the processing result of the dToF sensor 145, which are stored in the memory 163, for example, as descried with reference to FIG. 5, the data processing part 162 uses the processing result of the iToF sensor 142 as to the pixels of the distance measurement result closer thereto than the predetermined distance and uses the processing result of the dToF sensor 145 as to the pixels of the distance measurement result farther away therefrom than the predetermined distance, thereby generating a depth map and outputting the depth map to the bridge control part 161.

In other words, the data processing part 162 converts the distance measurement result of the iToF sensor 142 and the distance measurement result of the dToF sensor 145, the distance measurement system of the iToF sensor 142 and The distance measurement system of the dToF sensor 145 being different from each other, to the depth map which is the common data format and outputs the depth map as one distance measurement result to the bridge control part 161.

The bridge control part 161 outputs the depth map supplied from the data processing part 162 to the control device 131 via the data IF 141b (data output).

The above-described processing is repeated until an instruction to finish the distance measurement is issued from the control device 131.

As described above, the projection of the distance measuring light to the iToF sensor 142 and the projection of the distance measuring light to the dToF sensor 145 are alternately repeated, and within a period in which the distance measuring light is projected to the dToF sensor 145, the data processing of the pixel signals of the iToF sensor 142 is performed and the distance measurement result is outputted and within a period in which the distance measuring light is projected to the iToF sensor 142, the data processing of the pixel signals of the dToF sensor 145 is performed and the distance measurement result is outputted.

Here, as to the light emission (light projection) of the distance measuring light of the light emitting part 147 to the dToF sensor 145 and the exposure, as shown in a right portion in an upper row in FIG. 15, within the exposure period, the exposure and the light emission are repeated, for example, in the line unit, thereby making a noise countermeasure and generating the histogram.

In other words, in the right portion in the upper row in FIG. 15, it is shown that within the exposure enclosed by a one-dot chain line, at time t51, t52, . . . to at predetermined time intervals, the light emitting triggers (dToF) are outputted and exposure Ex1, Ext2, . . . Exn in a predetermined period from corresponding timing is repeated in the line unit. It is to be noted that a light emission frequency of the light emitting trigger (dToF) is a low frequency, as compared with a light emission frequency of the light emitting trigger (iToF).

In addition, since in general, power consumption required for the light emission of the light emitting part 147 to the dToF sensor 145 is larger than power consumption required for the light emission of the light emitting part 144 to the iToF sensor 142, although an example in which whereas the light emission of the light emitting part 144 is performed in one frame unit, the light emission of the light emitting part 147 is performed in the line unit is described, any of the units may be frame units or may be line units.

By the above-described series of processing by the bridge processing part 141, it is only required for the control device 131 to issue the instruction to start and finish the distance measurement to the distance measuring device 132, thereby making it possible to acquire the depth map as the distance measurement result.

In addition, even if distance measurement results in different formats are outputted to the distance measuring device 132 from distance measurement systems which are different from each other, it is made possible to convert the distance measurement results to information in a common data format as with the depth map by the bridge processing part 141 and output the information.

In any case, upon performing the distance measurement, control processing of the control device 131 can be simplified.

It is to be noted that although hereinbefore, the example in which as the processing result, the depth map is outputted is described, as long as the processing result uses the distance measurement result by the iToF sensor 142 and the distance measurement result by the dToF sensor 145, the processing result may be information other than the depth map and may be, for example, peak information pertinent to each of the pixels of the dToF.

In addition, although hereinbefore, the example in which the data processing of the iToF sensor 142 and the data processing of the dToF sensor 145 are execute at the respectively independent timings is described, as long as the respective timings, at each of which the distance measuring light is projected and is received, are different from each other, the data processing of the iToF sensor 142 and the data processing of the dToF sensor 145 may be concurrently and parallelly processed.

Furthermore, although hereinbefore, the example in which the bridge processing part 141 outputs the light emitting triggers to the iToF sensor 142 and the dToF sensor 145 is described, the bridge processing part 141 may output the light emitting trigger to the sensor of either one of the iToF sensor 142 or the dToF sensor 145, and after the sensor of either one thereof which has received the light emitting trigger executes the light emission and the light reception, at timing at which the sensor of either one thereof start the data processing, the light emitting trigger may be outputted to the other sensor thereof.

In other words, without outputting the light emitting triggers in the control device 131, the light emitting triggers may be adjusted in the distance measuring device 132.

<<3. Modified Examples >>

<Variation (Part 1)>

Although hereinbefore, the example in which the iToF sensor 142 and the dToF sensor 145 are connected to the bridge processing part 141 is described, the number of the distance measuring sensors connected thereto may be any number other than two, and any distance measuring sensors other than the iToF sensor 142 and the dToF sensor 145 may be connected thereto.

In other words, as shown in FIG. 16, only the iToF sensor 142 may be connected to the bridge processing part 141

<Variation (Part 2)>

In addition, as shown in FIG. 17, only the dToF sensor 145 may be connected to the bridge processing part 141.

<Variation (Part 3)>

Furthermore, as shown in FIG. 18, two iToF sensors 142 may be connected to a bridge processing part 141, and light emitting parts whose light emission frequencies are different from each other may be respectively connected to the iToF sensors 142.

In other words, in FIG. 18, iToF sensors 142-1 and 142-2 are connected to the bridge processing part 141, and LDs 143-1 and 143-2 and light emitting parts 144-1 and 144-2 are respectively connected to the iToF sensors 142-1 and 142-2.

The iToF 142-1 causes the light emitting part 144-1 to emit light at a frequency of, for example, approximately 320 MHz and receives the light, thereby measuring a distance in a range of approximately 80 cm to 90 cm.

The iToF 142-2 causes the light emitting part 144-2 to emit light at a frequency of, for example, approximately 40 MHz and receives the light, thereby measuring a distance in a range of approximately 7 m.

In this case, the bridge processing part 141 outputs light emitting triggers corresponding to the light emission frequencies of the respective light emitting parts 144-1 and 144-2 to the iToF sensors 142-1 and 142-2 at timings which allow time-division processing.

<Variation (Part 4)>

Furthermore, as shown in FIG. 19, in addition to the iToF sensor 142 and the dToF sensor 145, a millimeter-wave sensor may be connected to the bridge processing part 141.

FIG. 19 shows a configuration example of a distance measuring device 132 in which in addition to the iToF sensor 142 and the dToF sensor 145, the millimeter-wave sensor is connected to the bridge processing part 141.

In the distance measuring device 132 in FIG. 19, components having the same functions of the components in the distance measuring device 132 in FIG. 4 are denoted by the same reference signs, and description therefor will be appropriately omitted.

In other words, the distance measuring device 132 in FIG. 19 is different from the distance measuring device 132 in FIG. 4 in that a millimeter-wave sensor 201, a driver 202, and a millimeter-wave generation part 203 are newly included. In addition, the bridge processing part 141 in FIG. 19 controls the millimeter-wave sensor 201 in addition to the iToF sensor 142 and the dToF sensor 145.

When having acquired a start trigger which is supplied from the bridge processing part 141 and generates millimeter-waves from the millimeter-wave generation part 203, the millimeter-wave sensor 201 outputs a trigger to cause the driver 202 to generate the millimeter-waves. On the basis of the trigger supplied from the millimeter-wave sensor 201 to generate the millimeter-waves, the driver 202 controls the millimeter-wave generation part 203 to generate the millimeter-waves at a predetermined frequency.

At this time, the millimeter-wave sensor 201 receives millimeter-waves generated when the millimeter-waves generated from the millimeter-wave generation part 203 are reflected by a targeted object Tg, calculates a distance up to the object Tg from a timing at which the millimeter-waves are generated and a timing at which the millimeter-waves are received, and supplies the distance to the bridge processing part 141.

On the basis of distance measurement results of the iToF sensor 142, the dToF sensor 145, and the millimeter-wave sensor 201, the bridge processing part 141 converts the distance measurement results to common information such as a depth map and supplies the common information to a control device 131.

<Operation of Distance Measuring Device in FIG. 19>

Next, with reference to a timing chart in FIG. 20, operation of the distance measuring device 132 in FIG. 19 will be described.

It is to be noted that in FIG. 20, in addition to those shown in the timing chart in FIG. 15, from the top, a start trigger of the millimeter-wave sensor (a millimeter-wave sensor start trigger); an exposure timing and a data output timing (millimeter-wave sensor processing); and a timing of a trigger (millimeter-waves) to cause the millimeter-wave sensor 201 to generate the millimeter-waves (a trigger (millimeter-waves)) are further shown.

It is to be noted that although as to the operation of the iToF sensor 142 and the operation of the dToF sensor 145, in FIG. 15, the data output timing in the iToF sensor 142 is after the exposure timing has been finished, in FIG. 20, the operation of the iToF sensor 142 and the operation of the dToF sensor 145 are basically the same except that the data output timing in the iToF sensor 142 is started after exposure for one line has been completed.

In addition, in a case where the iToF sensor 142 and the dToF sensor 145 measure distances in the same range, since when the iToF sensor 142 and the dToF sensor 145 measure the distances at the same timing, interference is caused, it is required for the iToF sensor 142 and the dToF sensor 145 to measure the distances at timings, which are different from each other, by the time-division processing. However, since the iToF sensor 142 and the dToF sensor 145 cannot sense the millimeter-waves generated by the millimeter-wave sensor 201, concurrent processing can be performed.

In other words, as shown in an upper row in FIG. 20, in a case where The iToF sensor 142 is first operated, for example, at time t0, when an instruction to start the distance measurement is issued from the control device 131, at time t1, the bridge control part 161 outputs the iToF sensor start trigger to start the distance measurement to the iToF sensor 142 and concurrently outputs the millimeter-wave sensor start trigger to the millimeter-wave sensor 201.

At time t1 to t11, on the basis of the iToF sensor start trigger, the iToF sensor 142 outputs the light emitting trigger (iToF) to emit the distance measuring light from the light emitting part 144 to the ED 143 at a predetermined frequency.

The LD 143 controls the light emitting part 144 by this light emitting trigger (iToF) and causes the light emitting part 144 to repeat light emission and light turning off, for example, in a frame unit at the predetermined frequency and to emit the distance measuring light.

In response to this, as shown in the iToF sensor processing, at time t1 to t11, the iToF sensor 142 performs exposure to receive reflected light and. accumulates pixel signals iToF0° and pixel signals iToF 180° in accordance with an amount of the received light as exposure results in the memory 163.

Then, at time t11, when the light emission of the light emitting part 144 to the iToF sensor 142 and the exposure by the iToF sensor 142 have been finished, at time t11 to t12, on the basis of the exposure results including the pixel signals iToF0° and pixel signals iToF 180° accumulated in the memory, the iToF sensor 142 executes the data processing described with reference to FIG. 8, generates the distance measurement results, and causes the memory 163 to store the distance measurement results (data output).

On the other hand, at time t11, since the light emission of the distance measuring light to the iToF sensor 142 has been finished, the bridge control part 161 supplies the dToF sensor start trigger which instructs the dToF sensor 145 to start light emission of the distance measuring light.

At time t11 to t122, on the basis of the dToF sensor start trigger, the dToF sensor 145 outputs, to the ID 146, the light emitting trigger (dToF) to cause the light emitting part 147 to emit light at the predetermined frequency.

On the basis of this light emitting trigger (dToF), the ID 146 controls the light emitting part 147 and causes the light emitting part 147 to repeat light emission and light turning off, for example, in a line unit and to project distance measuring light.

In response to this, at time t11 to t122, the dToF sensor 145 performs the exposure to receive the reflected light and accumulates the pixel signals dToF in accordance with the amount of the received light as the exposure result in the memory 163.

Then, at time t121, when the light emission of the light emitting part 147 to the dToF sensor 145 for the pixel signals dToF of one line and the exposure by the dToF sensor 145 have been finished, at time t121 to t123, on the basis of the accumulated pixel signals dToF as the exposure result, the dToF sensor 145 executes the data processing described with reference to FIG. 7, generates the distance measurement result, and causes the memory 163 to store the distance measurement result (data output).

Furthermore, at time t1 to t31, on the basis of the millimeter-wave sensor start trigger in order to generate the millimeter-waves, the millimeter-wave sensor 201 outputs, to the driver 202, the trigger (millimeter-waves) to generate the millimeter-waves from the millimeter-wave generation part 203 at the predetermined frequency.

In response to this trigger (millimeter-waves), the driver 202 controls The millimeter-wave generation part 203 and causes the millimeter-wave generation part 203 to generate the millimeter-waves, for example, in a frame unit at the predetermined frequency.

Concurrently, at time t1 to t31, the millimeter-wave sensor 201 performs exposure to receive reflected millimeter-waves and accumulates pixel signals in. accordance with intensities of the received millimeter-waves as an exposure result in the memory 163.

At time t31 to t2, the millimeter-wave sensor 201 performs exposure to receive the millimeter-waves accumulated in the memory 163, executes data processing on the basis of the exposure result including the pixel signals in accordance with the intensities of the received millimeter-waves, generates a distance measurement result, and causes the memory 163 to store the distance measurement result.

On the basis of the distance measurement result of the iToF sensor 142, the distance measurement result of the dToF sensor 145, and the distance measurement result of the millimeter-wave sensor 201, which are stored in the memory 163, the data processing part 162 generates a depth map and outputs the depth map to the bridge control part 161.

The bridge control part 161 outputs the depth map supplied from the data processing part 162 to the control device 131 via the data IF 141b (data output).

At time t2, the bridge control part 161 supplies, to the iToF sensor 142, the iToF sensor start trigger to instruct the iToF sensor 142 to start the light emission of the distance measuring light and supplies, to the millimeter-wave sensor 201, the millimeter-wave sensor start trigger to instruct the millimeter-wave sensor 201 to generate the millimeter-waves.

At time t2 to t13, on the basis of the iToF sensor start trigger, the iToF sensor 142 outputs, to the LD 143, the light emitting trigger (iToF) to cause the light emitting part 144 to emit the distance measuring light at the predetermined frequency.

The LD 143 controls the light emitting part 144 by this light emitting trigger (iToF) and causes the light emitting part 144 to repeat light emission and light turning off, for example, in a frame unit at the predetermined frequency and to emit the distance measuring light.

In response to this, as shown in the iToF sensor processing, at time t2 to t13, the iToF sensor 142 performs the exposure to receive the reflected light and accumulates, as the exposure result, the pixel signals iToF0° and the pixel signals iToF 180° in accordance with the amount of the received light in the memory 163.

Then, at time t13, when the light emission of the light emitting part 144 to the iToF sensor 142 and the exposure by the iToF sensor 142 have been finished, at time t13 to t125, on the basis of the exposure results including the pixel signals iToF0° and pixel signals iToF 180° accumulated in the memory 163, the iToF sensor 142 executes the data processing described with reference to FIG. 8 and causes the memory 163 to store the distance measurement results (data output).

On the other hand, at time t13, since the light emission of the distance measuring light to the iToF sensor 142 has been finished, the bridge control part 161 supplies the dToF sensor start trigger, which instructs the dToF sensor 145 to start the light emission of the distance measuring light, to the dToF sensor 145.

At time t13 to t125, on the basis of the dToF sensor start trigger, the dToF sensor 145 generates the light emitting trigger (dToF) to cause the light emitting part 147 to emit light at the predetermined frequency and outputs, to the ID 146, the light emitting trigger (dToF).

On the basis of this light emitting trigger (dToF), the LD 146 controls the light emitting part 147 and causes the light emitting part 147 to repeat light emission and light turning off, for example, in a line unit and to project distance measuring light.

In response to this, at time t13 to t125, the dToF sensor 145 performs the exposure to receive the reflected light and accumulates the pixel signals dToF in accordance with the amount of received light as the exposure result in the memory 163.

In addition, at time t124, when the light emission of the light emitting part to the dToF sensor 145 for one line and the exposure by the dToF sensor 145 have been finished, at time t124 to t126, on the basis of the pixel signals dToF accumulated in the memory 163 as the exposure result, the dToF sensor 145 executes the data processing described with reference to FIG. 7, generates the distance measurement result, and causes the memory 163 to store the distance measurement result (data output).

Furthermore, at time t2 to t32, on the basis of the millimeter-wave sensor start trigger, in order to generate the millimeter-waves, the millimeter-wave sensor 201 outputs, to the driver 202, the trigger (millimeter-waves) to generate the millimeter-waves from the millimeter-wave generation part 203 at the predetermined frequency.

In response to this trigger (millimeter-waves), the driver 202 controls the millimeter-wave generation part 203 and causes the millimeter-wave generation part 203 to generate the millimeter-waves, for example, in a frame unit at the predetermined frequency.

Concurrently, at time t2 to t32, the millimeter-wave sensor 201 performs the exposure to receive the reflected millimeter-waves and accumulates the pixel signals as the distance measurement result in accordance with the intensities of the received millimeter-waves in the memory 163.

At time t32 to t3, the millimeter-wave sensor 201 performs the exposure to receive the millimeter-waves accumulated in the memory 163, processes data on the basis of the exposure result including the pixel signals in accordance with the intensities of the received millimeter-waves, generates the distance measurement result, and causes the memory 163 to store the distance measurement result.

On the basis of the distance measurement result of the iToF sensor 142, the distance measurement result of the dToF sensor 145, and the distance measurement result of the millimeter-wave sensor 201, which are stored in the memory 163, the data processing part 162 generates a depth map and outputs the depth map to the bridge control part 161.

The bridge control part 161 outputs the depth map supplied from the data processing part 162 to the control device 131 via the data IF 141b (data output).

The above-described processing is repeated until an instruction to finish the distance measurement is issued from the control device 131.

As described above, the projection of the distance measuring light to the iToF sensor 142 and the projection of the distance measuring light to the dToF sensor 145 are alternately repeated, and within a period in which the distance measuring light is projected to the dToF sensor 145, the data processing of the pixel signals of the iToF sensor 142 is performed and the distance measurement result is outputted and within a period in which the distance measuring light is projected to the iToF sensor 142, the data processing of the pixel signals of The dToF sensor 145 is performed and the distance measurement result is outputted.

In addition, since the millimeter-wave sensor 201 causes no interference between the millimeter-wave sensor 201 and the iToF sensor 142 or the dToF sensor 145, as described above, the processing can be concurrently executed.

However, also for the processing in the millimeter-wave sensor 201, as with the iToF sensor 142 and the dToF sensor 145, the time-division processing may be performed.

Furthermore, although in the description given hereinbefore, the example in which the bridge processing part 141 supplies the start triggers to the plurality of distance measuring sensors and the individual operation timings are controlled is described, processing in which the start trigger is supplied to either of the plurality of distance measuring sensors and at timing at which the distance measuring sensor having received the start trigger completes the exposure, the start trigger is supplied to the distance measuring sensor with no exposure performed may be sequentially repeated. However, start triggers may be concurrently supplied to distance measuring sensors which are operable to concurrently and parallelly perform distance measurement processing.

As described above, even in the case where the millimeter-wave sensor 201 is connected to the bridge processing part 141 in addition to the iToF sensor 142 and the dToF sensor 145, it is only required for the control device 131 to instruct the distance measuring device 132 to start and finish the distance measurement and it is made possible to acquire the depth map as the distance measurement result.

As a result, even in the case where the plurality of sensors whose distance measurement systems are different from each other is combined to be used, it is made possible to easily control the sensors as if a sensor of a single distance measurement system were handled.

In the present description, a system means aggregate of a plurality of components (devices, modules (parts), and the like) and it does not matter whether or not all the components are housed in the same housing. Accordingly, any of an apparatus including a plurality of devices which are housed in separate housings and are connected via a network and one apparatus in which a plurality of modules is housed in one housing is a system.

It is to be noted that an embodiment of the present disclosure is not limited to the above-described embodiment and various modification can be made without departing from the scope of the present disclosure.

For example, the present disclosure can adopt a configuration of cloud computing in which one function is shared by a plurality of devices via a network and is processed in collaboration with one another.

In addition, the steps described with reference to the above-described flowcharts can be executed by one device and in addition thereto, can be shared by a plurality of devices to be executed.

Furthermore, in a case where a plurality of processes is included in one step, the plurality of processes included in such one step can be executed by one device and in addition thereto, can be shared by a plurality of devices to be executed.

It is to be noted that the present disclosure can adopt the following configurations.

<1> A distance measuring device including:

a control part that controls a plurality of distance measuring sensors; and

a data processing part that generates common information on the basis of distance measurement results of the plurality of distance measuring sensors.

<2> The distance measuring device described in <1>, in which

in accordance with distance measurement systems of the plurality of distance measuring sensors, the control part controls operation timings of the plurality of distance measuring sensors.

<3> The distance measuring device described in <2>, in which

the plurality of distance measuring sensors includes a first distance measuring sensor and a second distance measuring sensor, and

in accordance with a distance measurement system of the first distance measuring sensor and a distance measurement system of the second distance measuring sensor, the control part controls the operation timings such that the first distance measuring sensor and the second distance measuring sensor operate in a time-division manner.

<4> The Distance Measuring Device Described in <3>, in which

in a case where when the first distance measuring sensor and the second distance measuring sensor concurrently operate, interference related to distance measurement is caused in accordance with the distance measurement systems of both of the first distance measuring sensor and the second distance measuring sensor, the control part controls the operation timings of the first distance measuring sensor and the second distance measuring sensor so as to allow the first distance measuring sensor and the second distance measuring sensor to operate in the time-division manner.

<5> The Distance Measuring Device Described in <4>, in which

in a case where the first distance measuring sensor is a distance measuring sensor of a direct Time of Flight (ToF) system and the second distance measuring sensor is a distance measuring sensor of an indirect Time of Flight (ToF) system, the control part controls the operation timings of the first distance measuring sensor and the second distance measuring sensor so as to allow the first distance measuring sensor and the second distance measuring sensor to operate in the time-division manner.

<6> The Distance Measuring Device Described in <4>, in which

in a case where the first distance measuring sensor is a distance measuring sensor of an indirect Time of Flight (ToF) system using distance measuring light of a first frequency and the second distance measuring sensor is a distance measuring sensor of an indirect Time of Flight (ToP) system using distance measuring light of a second frequency being different from the first frequency, the control part controls the operation timings of the first distance measuring sensor and the second distance measuring sensor so as to allow the first distance measuring sensor and the second distance measuring sensor to operate in the time-division manner.

<7> The Distance Measuring Device Described in <2>, in which

the plurality of distance measuring sensors includes a first distance measuring sensor and a second distance measuring sensor, and

in accordance with a distance measurement system of the first distance measuring sensor and a distance measurement system of the second distance measuring sensor, the control part causes at least one part of the operation timings of the first distance measuring sensor and the second distance measuring sensor to concurrently operate.

<8> The distance measuring device described in <7>, in which

in a case where the first distance measuring sensor is a distance measuring sensor of a Time of Flight (ToF) system and the second distance measuring sensor is a millimeter-wave sensor, the control part causes at least one part of operation timings of the first distance measuring sensor and the second distance measuring sensor to concurrently operate.

<9> The distance measuring device described in. <1>, in which

the plurality of distance measuring sensors includes a first distance measuring sensor and a second distance measuring sensor:,

the control part supplies, to the first distance measuring sensor, a start trigger to instruct the first distance measuring sensor to start operation, and

after light projection of distance measuring light and exposure related to distance measurement operation have been completed, the first distance measuring sensor supplies, to the second distance measuring sensor, a start trigger to instruct the second distance measuring sensor to start operation.

<10>The distance measuring device described in any one of <1> to <9>, in which

by selectively using the distance measurement results from the plurality of distance measuring sensors, the data processing part generates the common information.

<11> The distance measuring device described in <10>, in which

by selectively using the distance measurement results from the plurality of distance measuring sensors in accordance with distance measurement systems of the plurality of distance measuring sensors, the data processing part generates the common information.

<12> The distance measuring device described in <11>, in which

the plurality of distance measuring sensors includes a first distance measuring sensor and a second distance measuring sensor, and

by selectively using any of a distance measurement result of the first distance measuring sensor or a distance measurement result of the second distance measuring sensor in accordance with the distance measurement systems of the first distance measuring sensor and the second distance measuring sensor, the data processing part generates a depth map as the common information.

<13>The distance measuring device described in <12>, in which

the data processing part uses the distance measurement result of the first distance measuring sensor as to a distance measurement result at a farther distance than a predetermined distance and the distance measurement result of the second distance measuring sensor as to a distance measurement result at a closer distance than the predetermined distance in accordance with the distance measurement systems of the first distance measuring sensor and the second distance measuring sensor and generates a depth map as the common information.

<14>The distance measuring device described in. <13>, in which

the first distance measuring sensor is a distance measuring sensor of a direct Time of Flight (ToF) system and the second distance measuring sensor is a distance measuring sensor of an indirect Time of Flight (ToF) system.

<15>The Distance Measuring Device Described in <14>, in which

the distance measuring sensor of the direct ToF system has pixels being constituted of avalanche diodes, and

the distance measuring sensor of the indirect ToF system has pixels being constituted of current assisted photonic demodulators (CAPDs).

<16>The distance measuring device described in <1>, in which

on the basis of the distance measurement results from the plurality of distance measuring sensors, the data processing part generates peak information of each of pixels as the common information.

<17>A distance measuring method including the steps of:

controlling a plurality of distance measuring sensors; and

generating common information on the basis of distance measurement results of the plurality of distance measuring sensors.

### REFERENCE SIGNS LIST

131 Control device
132 Distance measuring device
141 Bridge processing part
142 iToF sensor
143 LD
144 Light emitting part
145 dToF sensor
146 LD
147 Light emitting part
161 Bridge control part
162 Data processing part
163 Memory
201 Millimeter-wave sensor
202 Driver
203 Millimeter-wave generation part

1. A distance measuring device comprising:
a control part that controls a plurality of distance measuring sensors; and
a data processing part that generates common information on a basis of distance measurement results of the plurality of distance measuring sensors.

2. The distance measuring device according to claim 1, wherein
in accordance with distance measurement systems of the plurality of distance measuring sensors, the control part controls operation timings of the plurality of distance measuring sensors.

3. The distance measuring device according to claim 2, wherein
the plurality of distance measuring sensors includes a first distance measuring sensor and a second distance measuring sensor, and
in accordance with a distance measurement system of the first distance measuring sensor and a distance measurement system of the second distance measuring sensor, the control part controls the operation timings such that the first distance measuring sensor and the second distance measuring sensor operate in a time-division manner.

4. The distance measuring device according to claim 3, wherein
in a case where when the first distance measuring sensor and the second distance measuring sensor concurrently operate, interference related to distance measurement is caused in accordance with the distance measurement systems of both of the first distance measuring sensor and the second distance measuring sensor, the control part controls the operation timings of the first distance measuring sensor and the second distance measuring sensor so as to allow the first distance measuring sensor and the second distance measuring sensor to operate in the time-division manner.

5. The distance measuring device according to claim 4, wherein
in a case where the first distance measuring sensor is a distance measuring sensor of a direct Time of Flight (ToF) system and the second distance measuring sensor is a distance measuring sensor of an indirect Time of Flight (ToF) system, the control part controls the operation timings of the first distance measuring sensor and the second distance measuring sensor so as to allow the first distance measuring sensor and the second distance measuring sensor to operate in the time-division manner.

6. The distance measuring device according to claim 4, wherein
in a case where the first distance measuring sensor is a distance measuring sensor of an indirect Time of Flight (ToF) system using distance measuring light of a first frequency and the second distance measuring sensor is a distance measuring sensor of an indirect Time of Flight (ToF) system using distance measuring light of a second frequency being different from the first frequency, the control part controls the operation timings of the first distance measuring sensor and the second distance measuring sensor so as to allow the first distance measuring sensor and the second distance measuring sensor to operate in the time-division manner.

7. The distance measuring device according to claim 2, wherein
the plurality of distance measuring sensors includes a first distance measuring sensor and a second distance measuring sensor, and
in accordance with a distance measurement system of the first distance measuring sensor and a distance measurement system of the second distance measuring sensor, the control part causes at least one part of the operation timings of the first distance measuring sensor and the second distance measuring sensor to concurrently operate.

8. The distance measuring device according to claim 7 wherein
in a case where the first distance measuring sensor is a distance measuring sensor of a Time of Flight (ToF) system and the second distance measuring sensor is a millimeter-wave sensor, the control part causes at least one part of operation timings of the first distance measuring sensor and the second distance measuring sensor to concurrently operate.

9. The distance measuring device according to claim 1, wherein
the plurality of distance measuring sensors includes a first distance measuring sensor and a second distance measuring sensor,
the control part supplies, to the first distance measuring sensor, a start trigger to instruct the first distance measuring sensor to start operation, and
after light projection of distance measuring light and exposure related to distance measurement operation have been completed, the first distance measuring sensor supplies, to the second distance measuring sensor, a start trigger to instruct the second distance measuring sensor to start operation.

10. The distance measuring device according to claim 1, wherein
by selectively using the distance measurement results from the plurality of distance measuring sensors, the data processing part generates the common information.

11. The distance measuring device according to claim 10, wherein
by selectively using the distance measurement results from the plurality of distance measuring sensors in accordance with distance measurement systems of the plurality of distance measuring sensors, the data processing part generates the common information.

12. The distance measuring device according to claim 11, wherein
the plurality of distance measuring sensors includes a first distance measuring sensor and a second distance measuring sensor, and
by selectively using any of a distance measurement result of the first distance measuring sensor or a distance measurement result of the second distance measuring sensor in accordance with the distance measurement systems of the first distance measuring sensor and the second distance measuring sensor, the data processing part generates a depth map as the common information.

13. The distance measuring device according to claim 12, wherein
the data processing part uses the distance measurement result of the first distance measuring sensor as to a distance measurement result at a farther distance than a predetermined distance and the distance measurement result of the second distance measuring sensor as to a distance measurement result at a closer distance than the predetermined distance in accordance with the distance measurement systems of the first distance measuring sensor and the second distance measuring sensor and generates a depth map as the common information.

14. The distance measuring device according to claim 13, wherein
the first distance measuring sensor is a distance measuring sensor of a direct Time of Flight (ToF) system and the second distance measuring sensor is a distance measuring sensor of an indirect Time of Flight (ToF) system.

15. The distance measuring device according to claim 14, wherein
the distance measuring sensor of the direct ToF system has pixels being constituted of avalanche diodes, and
the distance measuring sensor of the indirect ToF system has pixels being constituted of current assisted photonic demodulators (CAPDs).

16. The distance measuring device according to claim 1, wherein
on a basis of the distance measurement results from the plurality of distance measuring sensors, the data processing part generates peak information of each of pixels as the common information.

17. A distance measuring method comprising the steps of:
controlling a plurality of distance measuring sensors; and
generating common information on a basis of distance measurement results of the plurality of distance measuring sensors.
